(19) United States
(12) Patent Application Publication
(10) Pub. No.: US 2007/0016719 A1
(43) Pub. Date: Jan. 18, 2007

(54) Memory device including nonvolatile memory and memory controller

(76) Inventors: Nobuhiro Ono, Yokohama-shi (JP); Ayako Tsuji, Yokohama-shi (JP); Mitsunori Tadokoro, Fujisawa-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/101,440

(22) Filed: Apr. 8, 2005

(30) Foreign Application Priority Data
Apr. 9, 2004 (JP) 2004-115701

(51) Int. Cl. G06F 12/00

(52) U.S. Cl. 711/103; 711/118

(57) ABSTRACT

A memory device includes a first nonvolatile memory and a second nonvolatile memory. The first nonvolatile memory is used as a main memory and includes a plurality of physical blocks which store data. The second nonvolatile memory is used as a cache memory for the first nonvolatile memory and includes a plurality of block entries which store data and an information table in which cache management information used to allow the second nonvolatile memory to operate as the cache memory is stored.

### CROSS-REFERENCE TO RELATED APPLICATIONS

This application is based upon and claims the benefit of priority from prior Japanese Patent Application No. 2004-115701, filed Apr. 9, 2004, the entire contents of which are incorporated herein by reference.

### BACKGROUND OF THE INVENTION

1. Field of the Invention

The present invention relates to a mixed memory system comprising a memory controller, a nonvolatile memory, and flash memory, and for example, to a device comprising a nonvolatile memory and which can perform a data access to a flash memory at high speed, while improving the integrity of data, as well as a memory controller.

2. Description of the Related Art

A conventional problem with flash memories, for example, NAND flash ROMs is overhead during a data write operation. A method for writing data to a NAND flash ROM generally involves performing a new write operation on an erased new block and then setting an old block in an erased state. On this occasion, data in a region not overwritten by the new write operation must be copied to a new block. Thus, the overhead corresponds to the process for copying the data that must be moved in association with the write operation. Further, in this manner, the block write operation is performed on condition that valid free blocks are present in the NAND flash ROM. It is impossible to use all of the actual memory capacity in the NAND flash memory in order to provide these free blocks.

A problem with the flash memory, which is nonvolatile, is its lifetime. The number of rewrite operations that can be performed on the flash memory is limited. Accordingly, frequent data write operations rapidly reduce the lifetime of the flash memory. In particular, data is written to the NAND flash ROM in block units because data is erased from the NAND flash ROM in block units and because before a data write operation, data must be erased from a region in which the write operation is to be performed. This means that every time data smaller than a block size is written to the NAND flash ROM, erase and write operations must be performed on blocks and a write operation is performed over an unnecessarily large region. This affects memories of the flash type which are limited in the number of possible rewrite operations.

To cope with these problems, a technique has been disclosed which provides a volatile memory serving as a data buffer, in addition to a NAND flash ROM used as a main memory (see, for example, Jpn. Pat. Appln. KOKAI Publication No. 2003-242788).

However, since this technique uses a nonvolatile memory, it is disadvantageously difficult to ensure the integrity of data if a power supply is disconnected. When data is written to the NAND flash ROM, data from an old block is completely written to a new block when the data is completely erased from the old block after the block write operation has been completed. If the processing is unintentionally stopped owing to the disconnection of the power supply or the like, then logically, two blocks having the same address may result depending on the time at which the processing is stopped. This requires a recovery process of, for example, deleting one of the blocks for subsequent data accesses. On this occasion, deleting the block to which the data has been newly written removes the newly written data. Deleting the old block may result in the state in which the newly written data is incomplete. Thus, a problem with the above technique is the integrity of data affected when write processing is suddenly stopped. This is not limited to the NAND flash ROM but applies to other flash memories provided that they require similar processing. Moreover, during data write processing, a write operation is also preformed on a main memory. This simply corresponds to the use of hardware for realizing processing usually executed by software.

Another problem with the NAND flash ROM relates to an interface. Since the NAND flash ROM is specified so as to allow the presence of bad blocks, the bad blocks must be managed during data accesses. A method for managing bad blocks involves generating and updating a logical/physical conversion table containing information indicating correspondences between logical addresses to be accessed and physical addresses, which are actual ones, and utilizing the table to realize accesses to normal blocks, while avoiding bad blocks. This means that physical addresses cannot be utilized as logically consecutive addresses. This in turn complicates data accesses to the NAND flash ROM. This problem is not limited to the NAND flash ROM but applies to other flash memories provided that they require similar processing.

### BRIEF SUMMARY OF THE INVENTION

According to a first aspect of the present invention, there is provided a memory device comprises a first nonvolatile memory used as a main memory; and a second nonvolatile memory used as a cache memory for the first nonvolatile memory.

According to a second aspect of the present invention, there is provided a memory device comprises a first nonvolatile memory used as a main memory and including a plurality of physical blocks which store data; and a second nonvolatile memory used as a cache memory for the first nonvolatile memory and including a plurality of block entries which store data and an information table in which cache management information used to allow the second nonvolatile memory to operate as the cache memory is stored.

According to a third aspect of the present invention, there is provided a memory controller which controls a memory configuration using a first nonvolatile memory as a main memory and a second nonvolatile memory as a cache memory for the first nonvolatile memory, the memory controller comprising a cache control section which references an information table stored in the second nonvolatile memory, in response to a data access request, to perform a data access to a block entry in the second nonvolatile memory; a write back function section which references the information table to write data in the block entry back to a physical block in the first nonvolatile memory which corresponds to the block entry; and an access control section which receives the data access request and an address of the physical block from the cache control section to perform a data access to the first nonvolatile memory.

According to a fourth aspect of the present invention, there is provided a method for controlling a first and second nonvolatile memories, the method comprising determining whether a logical block to be accessed is registered in a block entry in the second nonvolatile memory; if the logical block is registered in the block entry, determining whether data in a page partition in the block entry which is to be accessed is valid; if the data in the page partition in the block entry which is to be accessed is not determined to be valid, fetching the data in the page partition from the first nonvolatile memory; storing the data fetched from the page partition in the page partition entry in the block entry in the second nonvolatile memory and updating a storage bit corresponding to the page partition; after the storage bit is updated, accessing the page partition in the block entry which is to be accessed; if the data in the page partition in the block entry which is to be accessed is determined to be valid, accessing the page partition in the block entry which is to be accessed; if the logical block to be accessed is not determined to be registered in the block entry in the second nonvolatile memory, determining whether or not there is any free block entry which is not used for registration; if no free block entry is determined to be present, writing data in a block entry back to the physical block in the first nonvolatile memory and making the block entry free; if any free block entry is determined to be present, determining whether or not the physical block in the first nonvolatile memory has been assigned to the logical block to be accessed; if the physical block in the first nonvolatile memory is not determined to have been assigned to the logical block to be accessed, assigning the physical block in the first nonvolatile memory to the logical block to be accessed; and if the physical block in the first nonvolatile memory is determined to have been assigned to the logical block to be accessed, assigning the block entry corresponding to the logical block to the logical block to be accessed.

### BRIEF DESCRIPTION OF THE SEVERAL VIEWS OF THE DRAWING

FIG. 1 is a block diagram showing the configuration of a device comprising a nonvolatile memory according to a first embodiment of the present invention, for example, a memory card;

FIGS. 2A, 2B, and 2C are schematic diagrams showing a memory map of a FeRAM according to the first embodiment of the present invention and an example of an information table;

FIG. 3 is a flowchart showing basic processing executed by a cache control section according to the first embodiment of the present invention;

FIG. 4 is a flowchart showing basic processing executed by a write back function section according to the first embodiment of the present invention;

FIG. 5 is a block diagram showing the configuration of a device comprising a nonvolatile memory according to a second embodiment of the present invention, for example, a memory card; and

FIG. 6 is a flowchart showing prefetch processing executed by a prefetch function section according to the second embodiment of the present invention.

### DETAILED DESCRIPTION OF THE INVENTION

### First Embodiment

Embodiments of the present invention will be described below with reference to the drawings.

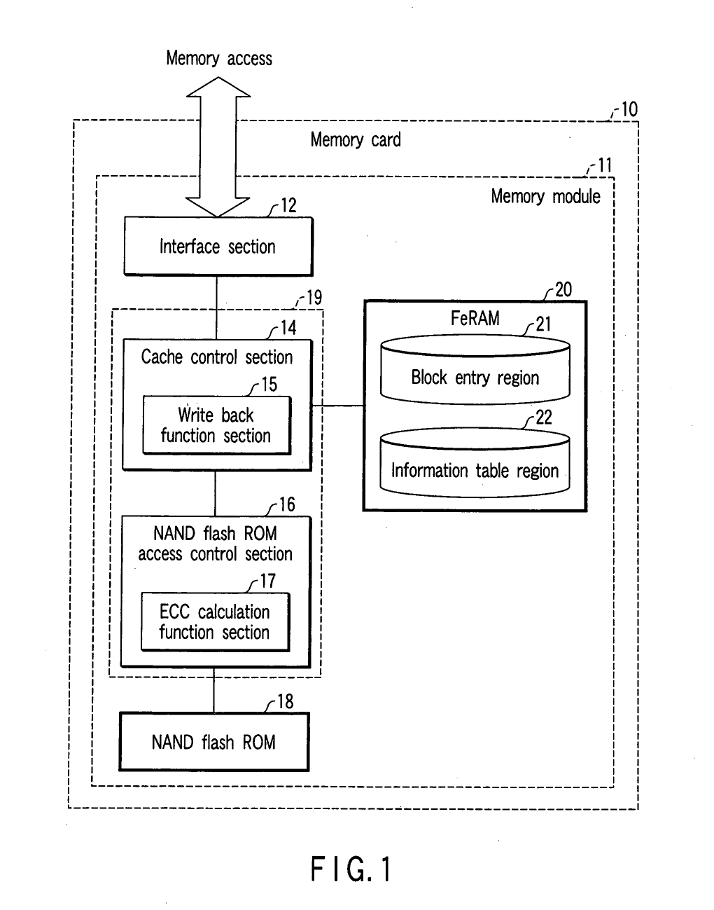

FIG. 1 is a block diagram showing the configuration of a device comprising a nonvolatile memory according to a first embodiment of the present invention, for example, a memory card. The device comprising the nonvolatile memory is not limited to the memory card embodiment shown in FIG. 1 but may be another device such as a portable information equipment terminal or a fixing computer device provided that it comprises a nonvolatile memory. A mixed memory system will be described below in which a nonvolatile memory (for example, a ferroelectric RAM [referred to as an FeRAM below]) is used as a cache memory and in which a flash memory (in the specification, for example, a NAND flash ROM) is used as a main memory.

A memory card 10 has a memory module 11 housed and mounted in a card type cache made of plastic or the like.

The memory module 11 has an interface section 12, a cache control section 14, a NAND flash ROM access control section 16, a NAND flash ROM 18, and an FeRAM 20. The cache control section 14 and the NAND flash ROM access control section 16 constitute a memory controller 19. The cache control section 14 comprises a write back function section 15. The NAND flash ROM access control section 16 comprises an ECC calculation function section 17. The FeRAM 20 comprises a block entry region 21 used to store data and an information table region 22 used to control a cache. The NAND flash ROM 18, for example, a NAND flash ROM having a capacity of 512 bytes per page, but is not limited to this configuration.

The interface section 12 is configured to have, for example, an interface equivalent to an asynchronous SRAM (Static Random Access Memory). A simple interface can be used as the interface section 12.

The FeRAM 20 has a block entry region 21 having a plurality of block entries corresponding to size units of physical blocks provided in the NAND flash ROM 18 and the information table region 22 in which the following are stored: physical block addresses in the NAND flash ROM 18 corresponding to logical block numbers, addresses in FeRAM 20, and cache management information.

The cache control section 14 accesses data in the block entry region 21 in FeRAM 20 while referring the information table region 22, which is present in FeRAM 20, in response to a data access request from the interface section 12. This will be described later.

The write back function section 15 serves to assist the cache control section 14.

The NAND flash ROM access control section 16 refers to a common NAND flash ROM controller that realizes accesses to the NAND flash ROM 18. The NAND flash ROM access control section 16 receives a physical address in the NAND flash ROM 18 for which an access request from the cache control section 14 is intended and the type of data access (page read/block data write). On the basis of these data, the NAND flash ROM access control section 16 executes a data access to the NAND flash ROM 18. During the data access, the NAND flash ROM access control section 16 utilizes an ECC calculation value for access data via the ECC calculation function section 17. Further, during a data write operation, the NAND flash ROM access control section 16 writes an ECC calculation value for write data in a redundancy section data region provided for each page in the NAND flash ROM 18. Moreover, during a data read operation, the NAND flash ROM access control section 16 compares the ECC calculation value in the redundancy section data region with an ECC calculation value for read data to make 1-bit error corrections as required before reading data. Data subjected to a 1-bit error correction is not written back to the NAND flash ROM 18. The following processing method is executed if an uncorrectable bit error containing an error of 2 or more bits is detected; the cache control section 14 is notified that the uncorrectable error has been detected at the same time when the corresponding data is returned to the cache control section 14, and the cache control section 14 sets, in an “unassigned” state, a physical addresses in the NAND flash ROM 18 for the corresponding logical block and block entry information stored in the block entry information in FeRAM 20. A physical block in the NAND flash ROM 18 which has been determined to be bad is marked as a bad block or subjected to other processing. However, this processing is not particularly limited.

The ECC calculation function section 17 serves to assist the NAND flash ROM access control section 16. The ECC calculation function section 17 executes a 22-bit ECC calculation for every 256 bytes in order to improve the reliability of the data in the NAND flash ROM 18 (of course, the present invention is not limited to this configuration).

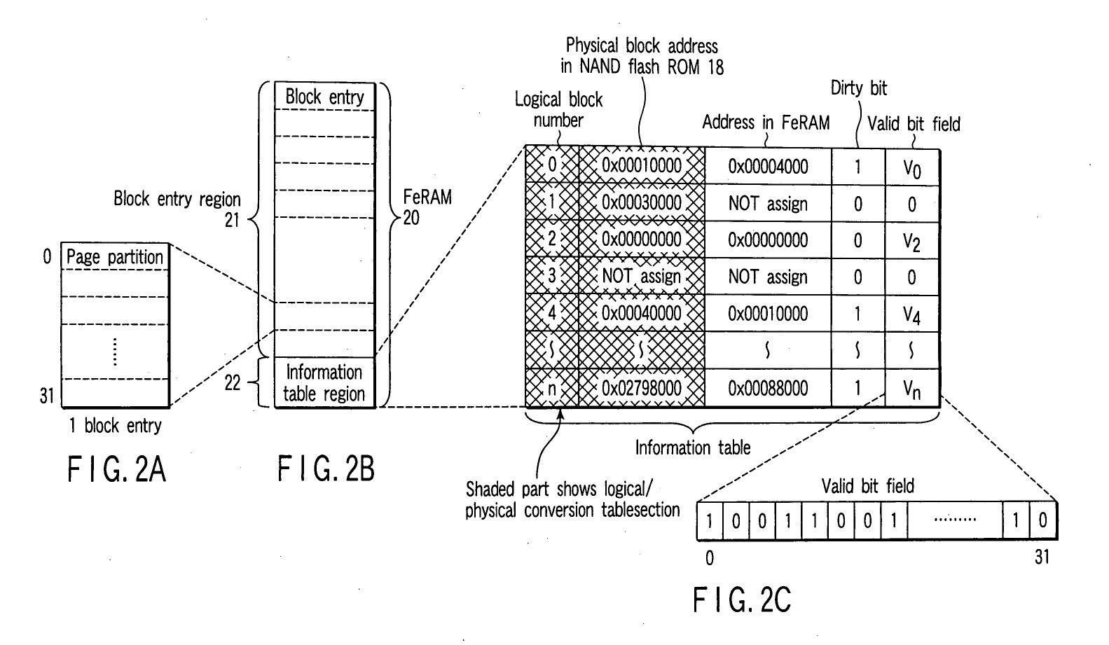

FIGS. 2A, 2B, and 2C show a memory map of FeRAM 20 and an example of an information table. The information table provides necessary and sufficient information in accordance with a processing algorithm provided by the cache control section 14. The information table does not always take the information table form shown in FIG. 2C.

The FeRAM 20 is composed of the block entry region 21, in which the plurality of block entries are stored, and the information table region 22, which stores the information table, as shown in FIG. 2B.

The block entries 21a to 21n stored in the block entry region 21 have the size units of physical blocks in the NAND flash ROM 18. Each of the block entries 21a to 21n is divided into page partitions each corresponding to one page (512 bytes) in the NAND flash ROM 18 (in FIG. 2A, 32 page partitions 0 to 31), as shown in FIG. 2A.

The information table, stored in the information table region 22, retains status information on all the logical blocks (0 to n) in the memory that are to be realized, as shown in FIG. 2C. If a physical block in the NAND flash ROM 18 is assigned to a certain logical block, the corresponding physical block address is stored in the corresponding part of the information table. If a physical block in the NAND flash ROM 18 is assigned to a certain block entry, the corresponding address in FeRAM 20 is stored in the corresponding part of the information table. Moreover, attribute information (valid bit) indicating the validity of data in each page partition in the block entry is stored in a predetermined area (valid bit field) in the information table in FeRAM 20. When data is written to an assigned block entry in FeRAM 20 and if there is a difference between this data and the data in the corresponding physical block in the NAND flash ROM 18, dirty information (dirty bit) in the block entry is updated. The FeRAM 20 and the NAND flash ROM 18 transmit and receive data to and from each other via the cache control section 14. Data is read from the NAND flash ROM 18 in page units (lines in common caches) and written to the NAND flash ROM 18 in block units.

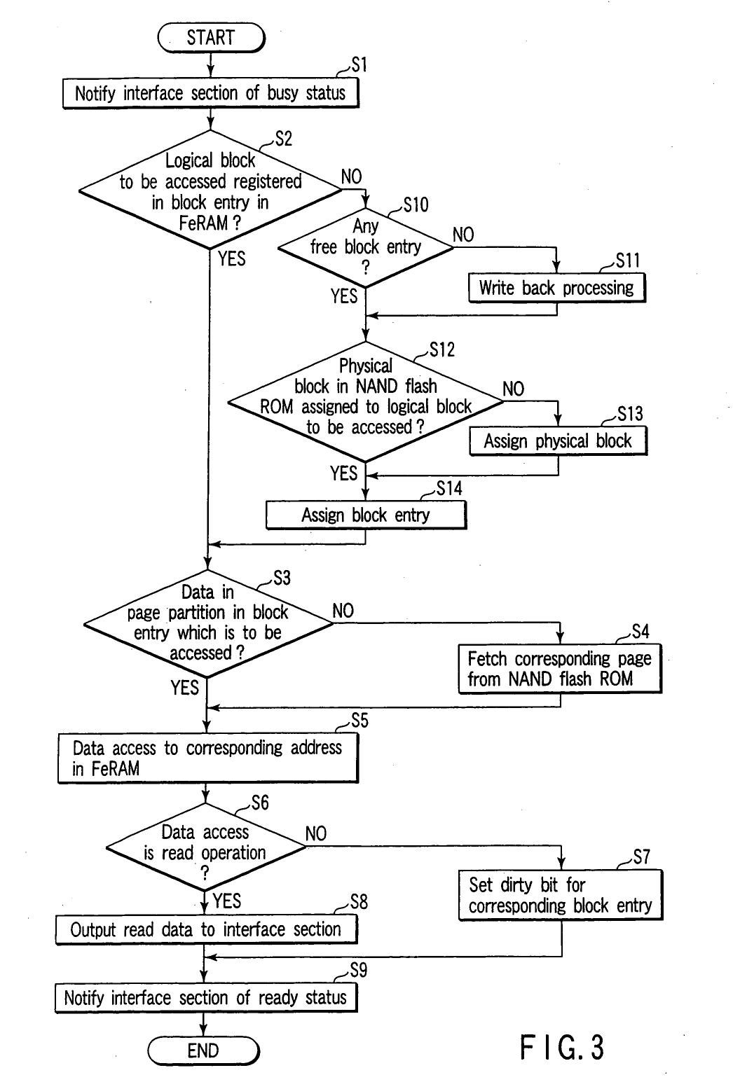

Now, with reference to the flowchart in FIG. 3, description will be given of basic processing executed by the cache control section.

A control section such as a CPU (not shown) notifies the interface section 12 of a busy status in step S1; the control section controls the memory module 11 according to the embodiment of the present invention. Then, the cache control section 14 determines in step S2 whether or not a logical block to be accessed is registered in any block entry in FeRAM 20. If the cache control section 14 determines in step S2 that the logical block to be accessed is registered in any block entry on FeRAM 20, it determines in step S3 whether or not the data in a page partition in the block entry which partition is to be accessed is valid.

If the cache control section 14 does not determine in step S3 that the data in the page partition in the block entry which is to be accessed is valid, then in step S4, it fetches the corresponding page from the NAND flash ROM 18. Subsequently, the cache control section 14 stores the data at the corresponding position in FeRAM 20 and then updates the corresponding valid bit. That is, if the data is invalid, the cache control section 14 fetches page data in which the target data is present from the NAN flash ROM 18 and stores the page data in the page partition in the block entry which partition is to be accessed. The cache control section 14 updates the valid bit corresponding to the page partition and then executes a data access to FeRAM 20.

On the other hand, if the cache control section 14 determines in step S3 that the data in the page partition in the block entry which partition is to be accessed is valid, then in step S5, it accesses the corresponding address in FeRAM 20. That is, the cache control section 14 acquires valid information corresponding to the page partition in FeRAM 20 which has the address to be accessed, from the valid bit field of the corresponding logical block in the information table. If the data is valid, the cache control section 14 executes a data access to FeRAM 20.

After accessing the corresponding address in FeRAM 20, the cache control section 14 determines in step S6 whether or not the access is for a read operation. If the access is not for a read operation (if it is for a rewrite operation or the like), then in step S7, the cache control section 14 sets the dirty bit indicating that the corresponding block entry has been rewritten. That is, if the data access is for a write operation, the cache control section updates the corresponding dirty bit and adds information indicating that a write operation has been performed on the block entry. The process then shifts to step S9.

On the other hand, if the access is for a read operation, then in step S8, FeRAM outputs read data to the interface section 12. Subsequently, in step S9, FeRAM 20 notifies the interface section 12 of a ready status. During access processing, the cache control section 14 notifies the interface section 12 of the busy status. After the access processing, the cache control section 14 notifies the interface section 12 of the ready status. The interface section 12 provides a ready/busy output in response to the notification.

Then in step S2, if the cache control section 14 does not determine that the logical block to be accessed is registered in any block entry in FeRAM 20, then it determines in step S10 whether or not there is any free block entry not user for registration. If the cache control section 14 does not determine in step S10 that there is any free block entry (the logical block is unregistered), then in step S11, it uses its write back function section 15 to execute a write back process of writing the data in an appropriate existing block entry back to the corresponding block in the NAND flash ROM 18 (this process will be described below later). The block entry made free by the write back process is used for a new assignment.

On the other hand, if the cache control section 14 determines in step S10 that there is any free block entry, the NAND flash ROM access control section 16 determines in step S12 whether or not any physical block in the NAND flash ROM 18 has been assigned to the logical block to be accessed. If the NAND flash ROM access control section 16 does not determine in step S12 that any physical block in the NAND flash ROM 18 has been assigned to the logical block to be accessed, then in step S13, it assigns a free physical block to the logical block to be accessed. For example, the following method can be used to assign a free physical block: “FeRAM 20 is provided with an information table relating to the frequency of write operations on each physical block of the NAND flash ROM 18 so as to allow the selection of a physical block with the smallest number of write operations”. However, the present invention is not limited to this method.

On the other hand, if the NAND flash ROM access control section 16 determines in step S12 that any physical block in the NAND flash ROM 18 has been assigned to the logical block to be accessed, then in step S14, the cache control section 14 assigns the block entry to the logical block to be accessed. Description has already been given of the processing executed after the assignment of the block entry.

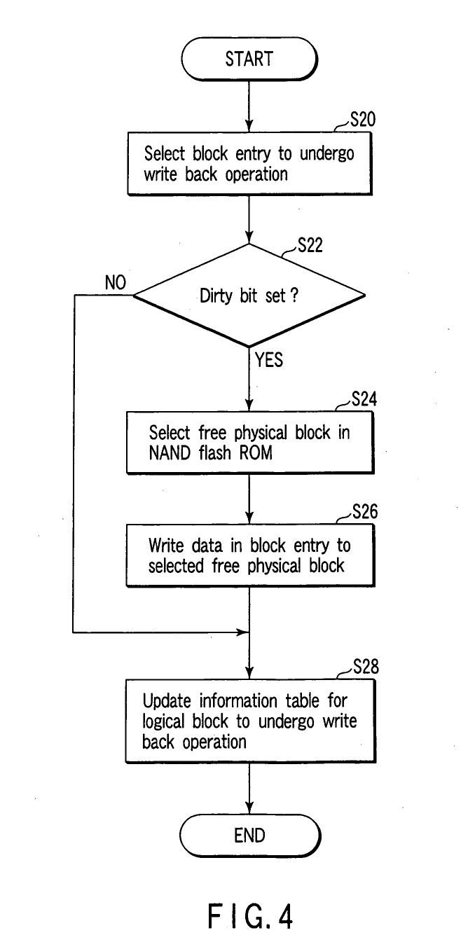

Now, the above write back process will be described below in detail. The write back function section 15 of the cache control section 14 serves to assist the cache control section 14. FIG. 4 shows the flow of basic processing.

In step S20, the write back function 15 selects one of the assigned block entries. Subsequently in step S22, the write back function section 15 determines whether or not the dirty bit in the block entry has been set. If the write back function section 15 determines in step S22 whether or not the dirty bit in the block entry has been set (the block entry has been rewritten), then in step S24, it selects a free physical block in the NAND flash ROM 18. In step S26, the write back function 15 writes the data stored in FeRAM 20 (corresponding block entry), in the selected free physical block in the NAND flash ROM 18 (the process of writing data from FeRAM 20 back to the NAND flash ROM 18: write back process). Of course, write processing on the NAN flash ROM 18 is executed after the data has been erased from a physical block to undergo a write operation, as in the case of write operations on common NAND flash ROMs. Subsequently, in step S28, the write back function section 15 updates the information table stored in the information table region 22 in FeRAM 20 (overwrites the physical block address to undergo a write back operation with the physical bock address at which data has been actually written and labels the block entry information on the corresponding logical block “unassigned”) to create a free block entry. If the write back processing is unintentionally suspended before it is completed, a new write back operation during the next access is ensured to be correctly performed.

For example, the following method is used to select a block entry to undergo a write back operation: “the FeRAM 20 is provided with an information table or list relating to the frequency of accesses to each block entry so as to allow the selection of a block entry with the lowest frequency of recent accesses”. However, the present invention is not particularly limited to this method. Further, for example, the following method is used to select a free physical block: “the FeRAM 20 is provided with an information table or list relating to free physical blocks in the NAND flash ROM 18 so as to allow the selection of a physical block with the smallest number of write operations”. However, the present invention is not particularly limited to this method.

The above configuration allows a data access to be executed directly on the cache memory even if data write processing is unintentionally stopped owing to the disconnection of the power supply or the like. Consequently, the data write operation performed on the cache memory is retained even after the power supply has been stopped. Further, even if write back processing is unintentionally suspended before it is completed, the information table held in the cache memory is updated after a write operation has been completely performed on a free block in the flash memory serving as a main memory. Thus, before the update of the information table, the original data in the blocks remain in the main memory (flash memory) as they are without being destroyed.

Further, since data is written to the cache memory, the overhead is eliminated, which corresponds to a process for copying data that must be moved in association with the write operation and the occurrence of which depends on the characteristics of the main memory (flash memory). Accordingly, data write speed is expected to be improved. In particular, a very high cache effect is expected for frequent operations for writing data of a block size or smaller. For example, if data smaller than the block size is frequently written to different blocks, when the main memory (flash memory) is directly accessed, a series of block write processes are executed on the NAND flash ROM for each operation of writing the small-sized data. However, the present embodiment can accomplish a reduction in the number of accesses to the main memory (flash memory) which reduction corresponds to cache hits (any of the block entries registered in the cache memory is accessed). Specifically, if 10,000 write operations are performed on each of 10 blocks while varying the block to be accessed (no other access processes are executed during these operations), the former method performs 10,000 write operations on the main memory (flash memory), while the latter performs no write operation (on condition that an amount of data corresponding to 10 blocks is contained in the cache). That is, accesses can be executed using the access capability of the cache memory, and no write processing is executed on the main memory (flash memory). This increases the lifetime of a mixed memory system compared to that of a unitary NAND flash ROM. That is, a write operation is performed on the flash memory, serving as a main memory, only if the data in a block entry in the nonvolatile memory is written back. Consequently, the temporal and spatial localities of data accesses allow the frequency of write operations on the flash memory to be reduced with increasing number of cache hits. As a result, the flash memory, which is limited in the number of possible write operations, can be more effectively used. In this manner, no write operations are performed on the flash memory, serving as a main memory, until the need arises. The present embodiment is thus different from the conventional technique (the technique of also performing write operations on the main memory (flash memory) during data write processing).

Further, the cache control section 14 uses the logical/physical address conversion table, held in FeRAM 20, to control accesses to the flash memory, serving as a main memory. Consequently, the complicated interface for data accesses to the main memory (flash memory) can be hidden and converted into another simple one.

### Second Embodiment

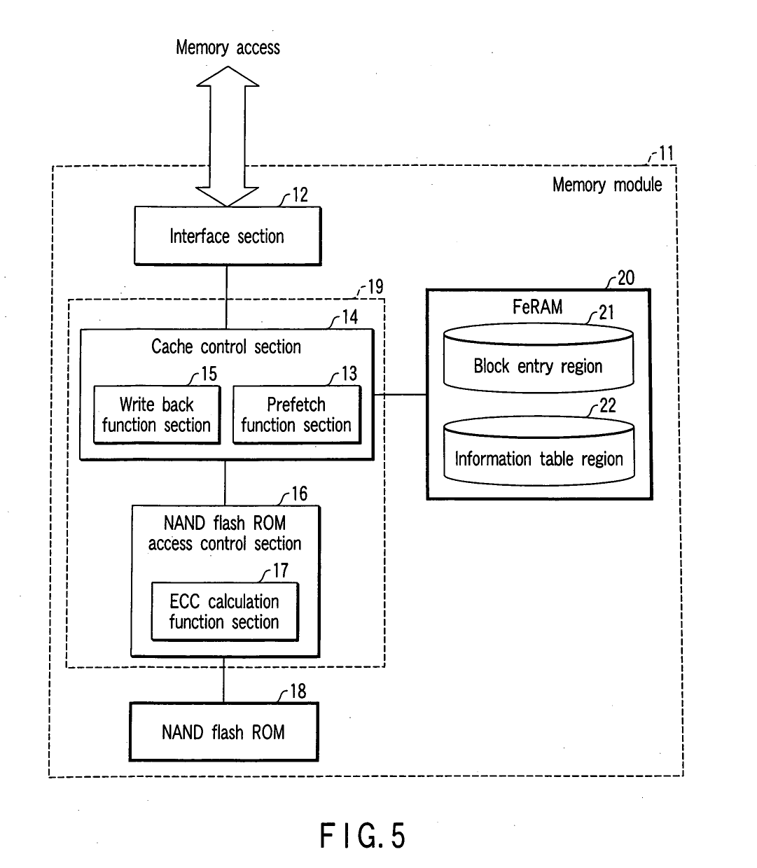

Now, with reference to FIG. 5, description will be given of a second embodiment according to the present invention. Arrangements similar to those of the first embodiment are as previously described and shown by the same reference numerals. Their detailed description is omitted. The second embodiment differs from the first embodiment in that the cache control section 14 comprises the prefetch function section 13 in addition to the write back function section 15. A main description will be given below of prefetch processing executed by the prefetch function section 13.

FIG. 5 is a block diagram showing the configuration of a device comprising a nonvolatile memory according to the second embodiment of the present invention, for example, a memory card. The cache control section 14 further comprises the prefetch function section 13. The other arrangements are similar to those of the first embodiment. The prefetch function section 13 utilizes the time during which no data accesses to FeRAM 20 occur to efficiently file cache data from the NAND flash ROM 18 to FeRAM 20, thus improving cache efficiency. The prefetch function section 13 serves to assist the cache control section 14.

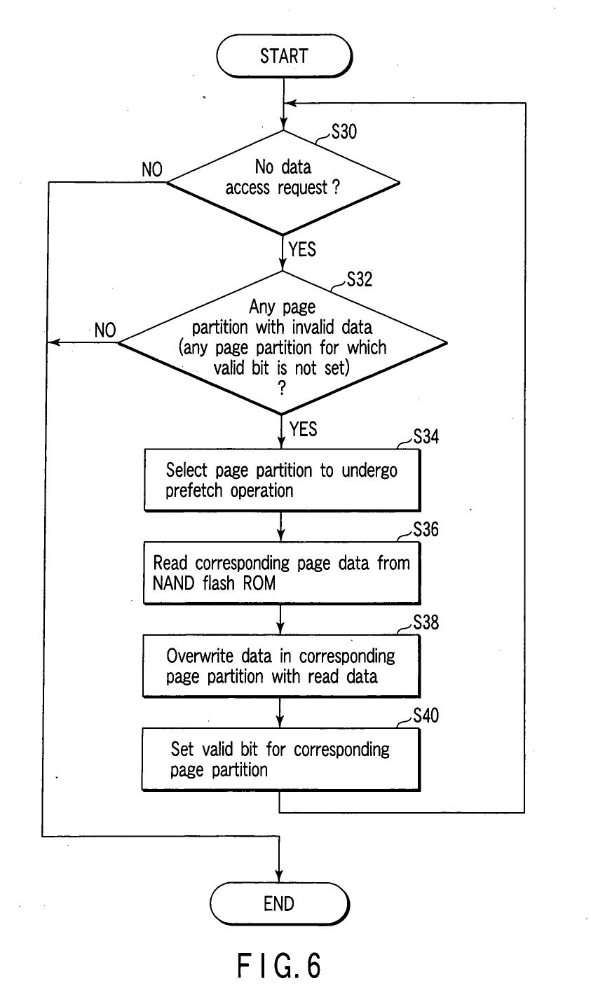

With reference to the flowchart in FIG. 6, description will be given of prefetch processing executed by the prefetch function section 13.

The prefetch function section 13 determines in step S30 whether or not the interface section 12 is making a data access request (including chip select) to the cache control section 14. If the prefetch function section 13 does not determine in step S30 that the interface section 12 is making a data access request to the cache control section 14, it determines in step S32 whether or not there is any page partition having an invalid attribute in a block entry stored in the block entry region 21 of FeRAM 20. If the prefetch function section 13 determines in step S32 that there is such a page partition, then in step S34, it selects a page partition having the invalid attribute in a block entry stored in the block entry region 21 of FeRAM 20. Subsequently in step S36, the prefetch function section 13 reads the corresponding page data from the NAND flash ROM 18 for the selected page partition. Subsequently, in step S38, the prefetch function section 13 stores the read valid data, and in step S40, sets the valid bit for the page partition.

Every time the data for each page partition is stored, the corresponding valid bit is updated. For example, the following method is used to select a page partition in which valid data is embedded: “the FeRAM 20 is provided with an information table or list relating to the frequency of accesses to each block entry so as to allow the sequential selection of page partitions in order of increasing earliness of accesses to the corresponding block entry and in order of increasing address”. However, the present invention is not particularly limited to this method.

The above configuration not only exerts the effects of the first embodiment but can also improve the cache efficiency of FeRAM to further improve access speed.

The present invention is not limited to the combination of the NAND flash ROM and FeRAM. Various changes may be made to the present invention within its scope set forth in the claims; for example, another nonvolatile memory or the like may be used. Naturally, these changes are included in the scope of the present invention. Moreover, according to the present invention, the memory module or memory controller is incorporated into the memory card. Accordingly, the present invention has the characteristics and advantages of a common memory card (improved easiness with which to handle the device, improved durability, and the like).

The embodiment of the present application can provide a device comprising a nonvolatile memory and which can accomplish fast and safe data accesses and a simple interface and which can extend the lifetime of the nonvolatile memory, used as a main memory, as well as a memory controller.

The above embodiments can not only be independently implemented but can also be appropriately combined together. Further, the present invention is not limited to the as-described embodiments. In implementation, the components of the embodiments can be varied without departing from the spirit of the present invention. Moreover, each of the above embodiments includes inventions at various levels. It is thus possible to extract the inventions at the various levels by appropriately combining together a plurality of the components disclosed in the embodiments.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A memory device comprising:
a first nonvolatile memory used as a main memory; and
a second nonvolatile memory used as a cache memory for the first nonvolatile memory.

2. The memory device according to claim 1, wherein the storage capacity of the second nonvolatile memory is smaller than that of the first nonvolatile memory, the limited number of write operations on the second nonvolatile memory is larger than that on the first nonvolatile memory, and write units in the second nonvolatile memory are smaller than those in the first nonvolatile memory.

3. The memory device according to claim 1, further comprising:
a memory controller which controls the first nonvolatile memory and the second nonvolatile memory,
wherein the memory controller accesses an information table stored in the second nonvolatile memory, and on the basis of the information table, the memory controller loads data stored in the first nonvolatile memory into the second nonvolatile memory, and obtain data via the second nonvolatile memory.

4. The memory device according to claim 1, wherein the first nonvolatile memory includes a NAND flash ROM, and the second nonvolatile memory includes FeRAM.

5. A memory device comprising:
a first nonvolatile memory used as a main memory and including a plurality of physical blocks which store data; and
a second nonvolatile memory used as a cache memory for the first nonvolatile memory and including a plurality of block entries which store data and an information table in which cache management information used to allow the second nonvolatile memory to operate as the cache memory is stored.

6. The memory device according to claim 5, further comprising:
an interface section which receives a data access request and a logical address from an external device and which transmits the data access request and logical address;
a cache control section which references the information table stored in the second nonvolatile memory in connection with the data access request and logical address from the interface section, to perform a data access to the block entry in the second nonvolatile memory which corresponds to the logical address;
a write back function section which writes data in the block entry back to the physical block in the first nonvolatile memory which corresponds to the block entry, with reference to the information table; and
an access control section which receives the data access request and an address of the physical block from the cache control section to perform a data access to the first nonvolatile memory.

7. The memory device according to claim 5, wherein the information table stores corresponding logical addresses, the address of the physical block in the first nonvolatile memory and an address of the block entry, attribute information, and dirty information, the attribute information indicates a validity of the data in the block entry, and the dirty information indicates whether or not there is any difference between the data in the block entry and the data in the physical block in the first nonvolatile memory which corresponds to the block entry.

8. The memory device according to claim 7, wherein each of the block entries has a capacity size equal to or larger than that of each of the physical blocks.

9. The memory device according to claim 5, wherein the first nonvolatile memory includes a NAND flash ROM, and the second nonvolatile memory includes FeRAM.

10. A memory controller which controls a memory configuration using a first nonvolatile memory as a main memory and a second nonvolatile memory as a cache memory for the first nonvolatile memory, the memory controller comprising:
a cache control section which references an information table stored in the second nonvolatile memory, in response to a data access request, to perform a data access to a block entry in the second nonvolatile memory;
a write back function section which references the information table to write data in the block entry back to a physical block in the first nonvolatile memory which corresponds to the block entry; and
an access control section which receives the data access request and an address of the physical block from the cache control section to perform a data access to the first nonvolatile memory.

11. The memory controller according to claim 10, wherein the cache control section accesses the information table stored in the second nonvolatile memory, and on the basis of the information table, the memory controller loads data stored in the first nonvolatile memory into the second nonvolatile memory, and obtain data via the second nonvolatile memory.

12. The memory controller according to claim 11, wherein the cache control section loads the data stored in the first nonvolatile memory into the second nonvolatile memory during a free time in which the second nonvolatile memory is not accessed.

13. A method for controlling a first and second nonvolatile memories, the method comprising:
determining whether a logical block to be accessed is registered in a block entry in the second nonvolatile memory;
if the logical block is registered in the block entry, determining whether data in a page partition in the block entry which is to be accessed is valid;
if the data in the page partition in the block entry which is to be accessed is not determined to be valid, fetching the data in the page partition from the first nonvolatile memory;
storing the data fetched from the page partition in the page partition in the block entry in the second nonvolatile memory and updating a storage bit corresponding to the page partition;
after the storage bit is updated, accessing the page partition in the block entry which is to be accessed;
if the data in the page partition in the block entry which is to be accessed is determined to be valid, accessing the page partition in the block entry which is to be accessed;
if the logical block to be accessed is not determined to be registered in the block entry in the second nonvolatile memory, determining whether or not there is any free block entry which is not used for registration;
if no free block entry is determined to be present, writing data in a block entry back to the physical block in the first nonvolatile memory and making the block entry free;
if any free block entry is determined to be present, determining whether or not the physical block in the first nonvolatile memory has been assigned to the logical block to be accessed;
if the physical block in the first nonvolatile memory is not determined to have been assigned to the logical block to be accessed, assigning the physical block in the first nonvolatile memory to the logical block to be accessed; and
if the physical block in the first nonvolatile memory is determined to have been assigned to the logical block to be accessed, assigning the block entry corresponding to the logical block to the logical block to be accessed.
